(19) United States
(12) Patent Application Publication
(10) Pub. No.: US 2011/0061379 A1
(43) Pub. Date: Mar. 17, 2011

(54) HEAT ENGINE

(76) Inventor: Jürgen Misselhorn, Filderstadt (DE)

(21) Appl. No.: 12/992,733

(22) PCT Filed: May 14, 2009
(86) PCT No.: PCT/EP09/03441

§ 371 Date: Nov. 15, 2010

(30) Foreign Application Priority Data
May 15, 2008 (DE) 10 2008 023 793.0

(51) Int. Cl. F02G 1/055; F02G 1/047

(52) U.S. Cl. 60/531

(57) ABSTRACT

In a heat engine that utilizes the energy content of a warm medium by a better exploitation of the isochoric changes of state in a cycle process having six changes of state (two isobars, two isochores and two isotherms) it is possible by means of the presently disclosed embodiments to minimize the constructive complexity. The heat engine comprises at least one pair of heat exchangers having one condenser and one evaporator. At least one working medium transfer device is arranged between the condenser and the evaporator of the pair of heat exchangers. At least one working engine driven by the working medium is provided. A conduit is provided between the condenser and the working engine and another conduit is provided between the evaporator and the working engine. Valve means are arranged between the pair of heat exchangers and the working engine and selectively open and close a fluid communication between these.

The present invention relates to a heat engine that implements a cycle process consisting of six changes of state (two isobars, two isochors and two isotherms). In particular it relates to such a heat engine having a simplified mechanical construction.

Heat engines currently used for power generation are mainly steam and gas turbines, combined heat and power (CHP) units and power generators with diesel or internal combustion engines. These generators, except the steam generation for steam turbines, operate to a minor extent with regenerative fuels.

All these heat engines have in common that they are only able to transform just a comparatively small part of the used energy, approx. 30-40%, into mechanical work, which is equivalent to electric power. The remaining 60-70% of primary energy is lost as heat energy, unless it is used as thermal heat.

In order to utilize this excess energy according to the heat requirements, different heat engines were developed, which also work at low temperatures with acceptable efficiency. One of these developments is the Organic Rankine Cycle (ORC), where organic compounds are employed instead of using water and steam as working substance, whose vaporisation temperatures and vapour pressures allow an operation at low temperatures. In recent years some of the ORC-systems have been taken into operation. By using ORC-systems, regenerative energy like geothermal power can be transformed into work.

With respect to the prior art, reference is made to the publication DE 10 2005 013287 B3 “Wärmekraftmaschine”, where a heat engine having heat exchangers is described, which performs its work using an external heat source. The work is generated by a cycle process that consists, of six changes of state: two isobars, two isochors and two isotherms. In the heat engine several of the cycles described above, take place at the same time, but chronologically displaced.

The heat exchangers of this known heat engine consist of two parts. One part is a condenser being cooled, the other part is an evaporator being heated. All heat exchangers are arranged in a star shaped manner around the central axis of the working cylinder and rotate around the same.

The heat engine according to the present invention has a relatively high efficiency even at low-temperature operating conditions. Among other things, the main purpose of this invention is to recover a part of waste heat of industrial process or power stations, which would normally be lost in warm or hot exhaust air.

Further, it is generally possible to recover energy from liquids as well as gases that were heated by regenerative energy sources to low temperature levels. Especially it is intended to convert a part of the heat, which usually cannot be utilized efficiently, by means of the presently described heat engine into electricity or work.

The invention is based on the problem to reduce the constructive complexity of a heat engine that makes use of the energy content of a hot medium by a better utilization of the isochoric changes of state.

The aim of the present invention is achieved by a heat engine that comprises at least one pair of heat exchangers comprising a condenser and an evaporator, at least one working medium transfer device being arranged between the condenser and the evaporator of the pair of heat exchangers, at least one working engine driven by the working medium having a conduit between the condenser and the working engine and a conduit between the evaporator and the working engine as well as valve means being arranged between the pair of heat exchangers and the working engine and that selectively open and close a fluid communication between these. In this way the number of components may be reduced and the sealing of the individual components is simplified.

Preferably the valve means comprise a valve, which is arranged between the condenser and the working engine within the conduit; and a valve, which is arranged between the evaporator and the working engine within the conduit, to allow for a flexible control of the operating sequence.

The condenser defines a closed internal chamber, and preferably the working fluid transfer device is connected to the lower part of the internal chamber in order to gather the condensed working medium as completely as possible.

The evaporator defines a closed internal chamber, and preferably the working fluid transfer device is connected to the upper part of the internal chamber in order to disperse the inserted condensed working fluid over the entire evaporator as uniformly as possible.

The working fluid transfer device preferably comprises at least one switchable working medium transport chamber, which is selectively connected to the evaporator in a first position, which is connected to the condenser in a second position, and which is closed towards the evaporator as well as the condenser in a third position. By this means an overflow or a pressure compensation between the evaporator and the condenser is prevented to minimize losses.

The working engine preferably comprises a working piston that defines a variable operation chamber in the working engine to directly generate work by means of the pressure differences between the condenser and the evaporator.

Further, the working engine advantageously comprises a working piston which defines a first and a second variable operation chamber together with the working cylinder in order to enable the working piston to be driven from two sides, which increases the efficiency of the heat engine.

Advantageously the conduit between the condenser and the working engine and the conduit between the evaporator and the working engine are both connected to the operation chamber to simplify the piping.

Advantageously a plurality of pairs of heat exchangers is provided with their condenser and evaporator being connected to an operation chamber. Thus, faster stroke times may be achieved as different cycles of the thermal cycle (evaporation and condensation) may take place at the same time in the heat exchangers.

Advantageously at least two pairs of heat exchangers are provided with each pair of heat exchangers being connected to the first or the second operation chamber to enable the working piston being driven from both sides. In this way a higher output of the heat engine is achieved.

Advantageously a plurality of pairs of heat exchangers is provided, the condensers and evaporators thereof being connected to a first operation chamber, and another plurality of pairs of heat exchangers is provided the condensers and evaporators thereof being connected to a second operation chamber. Thus faster stroke times may be achieved as different cycles of the thermal cycle (evaporation and condensation) may take place in the heat exchangers simultaneously. At the same time a higher output of the heat engine is achieved.

Advantageously means for distributing the working medium are arranged in the evaporators to achieve a better distribution and therefore a faster evaporation of the inserted condensed working medium.

Preferably the distribution means are capable of distributing the working medium over a large surface to provide for a fast heat transfer to the working medium and to enable faster stroke times in this way. The distribution means comprise an injection device, metallic wool, metal threads, surface structures or heat transfer fins to achieve a fast evaporation of the working medium.

Alternatively the aim of the invention is achieved by a heat engine further comprising a plurality of pairs of heat exchangers, each comprising a condenser and an evaporator; a plurality of working medium transfer devices, each being arranged between the condenser and the evaporator of each pair of heat exchangers; at least one working engine having first and second operation chambers, wherein a first group of pairs of heat exchangers is connected to the first operation chamber and wherein a second group of pairs of heat exchangers is connected to the second operation chamber. Conduits are arranged between the condensers of the first group of pairs of heat exchangers and the first operation chamber of the at least one working engine, and further conduits are arranged between the condensers of the second group of pairs of heat exchangers and the second operation chamber of the working engine. A plurality of valves is provided, wherein one of these valves is arranged within the conduit between each condenser and the operation chamber connected thereto of the at least one working engine, respectively. Furthermore, conduits are arranged between the evaporator of the first group of pairs of heat exchangers and the first operation chamber of the at least one working engine, and further conduits are arranged between the evaporator of the second group of pairs of heat exchangers and the second operation chamber of the at least one working engine. A plurality of valves is provided, wherein one of these is arranged in the conduit between each evaporator and the attached operation chamber of the at least one working engine, respectively. This results in the advantage that a plurality of cycles of the thermal cycle may be executed simultaneously, and faster stroke times may be achieved.

Alternatively the aim of the invention is achieved by a heat engine further comprising a plurality of pairs of heat exchangers, each comprising a condenser and an evaporator; a plurality of working medium transfer devices, each being arranged between the condenser and the evaporator of each pair of heat exchangers; at least one working engine having first and second operation chambers, wherein a first group of pairs of heat exchangers is connected to the first operation chamber, and wherein a second group of pairs of heat exchangers is connected to the second operation chamber. A conduit is provided between the condenser of the first group of pairs of heat exchangers and the first operation chamber of the working engine, wherein each condenser is connected to the conduit via a junction line, respectively. Furthermore a conduit is provided between the condensers of the second group of pairs of heat exchangers and the second operation chamber of the working engine, wherein each condenser is connected to the conduit via a junction line, respectively. In each case, a plurality of valves is individually arranged in the junction line between the condenser and the conduit connected thereto. Additionally a conduit is arranged between the evaporators of the first group of pairs of heat exchangers and the first operation chamber of the working engine, wherein each evaporator is connected to the conduit via a junction line. Conduits are arranged between the evaporators of the second group of pairs of heat exchangers and the second operation chamber of the working engine, wherein each evaporator is connected to the conduit via a junction line respectively. A plurality of valves is in each case individually arranged in the junction line between each evaporator and attached conduit connected thereto. This results in the advantage that a plurality of cycles of the thermal cycle may be executed simultaneously and faster stroke times may be achieved.

Advantageously the first group and the second group of pairs of heat exchangers each consist of three pairs of heat exchangers such that the six strokes of the employed thermal cycle may run offset by one stroke, respectively.

Advantageously the working engine is a piston engine having a linearly reciprocating piston to enable the use of established sealing and construction principles.

Alternatively the working engine is a rotary piston engine having rotating pistons to enable simple forwarding of the generated (rotational) output to a standard electric generator. Furthermore, the employment of a rotary piston engine results in a smaller size of the working engine.

Preferably the working medium transfer device comprises two valves between which a chamber is provided for the intake of condensate. This results in the advantage that simply controllable valves may be used, which are available in a large variety as purchased parts. In this way the constructional effort may be reduced.

The aim of the invention is achieved by a method for controlling the heat engine described above, the method comprising the following steps: a) closing the valve between the working cylinder and the condenser, b) closing the valve between the working cylinder and the evaporator, c) condensing a gaseous working medium in the condenser, d) collecting the condensed liquid working medium in the working medium transport chamber of the working medium transfer device, e) opening the valve between the working cylinder and the condenser, f) introducing the gaseous working medium into the condenser, g) collecting the condensed, liquid working medium in the working medium transport chamber of the working medium transfer device, h) closing the valves between the working cylinder and the condenser, i) pressure-tight sealing of the condensed liquid working medium in the working medium transport chamber of the condenser, j) directing the condensed liquid working medium into the evaporator, k) evaporating the condensed liquid working medium within the evaporator, l) opening the valve between the working cylinder and the evaporator, m) directing the evaporated working medium into the working cylinder, n) closing the valve between the working cylinder and the evaporator, o) repeating the steps starting from step c). Thus advantageously a high efficiency of the thermal cycle may be achieved without pressure losses.

The step k) of evaporating the working medium preferably takes place at least partly during the following steps: l) opening the valve and m) directing into the working cylinder to increase the thermal efficiency.

Preferably the method for controlling the above described heat engine comprises the following steps:
a) opening valves 40A, 41X, closing the valves 40B, 40C, 40X, 40Y, 40Z, 41A, 41B, 41C, 41Y, 41Z, collecting the condensed working medium in the working medium transfer devices 30A, 30B, 30C, 30X, 30Z;
b) opening valves 41B, 40Z, closing the valves 40A, 40B, 40C, 40X, 40Y, 41A, 41C, 41Y, 41Z, collecting the condensed working medium in the working medium transfer devices 30B, 30C, 30X, 30Y, 30Z;
c) opening valves 40C, 41Y, closing the valves 40A, 40B, 40X, 40Y, 40Z, 41B, 41C, 41X, 41Y, 41Z collecting the condensed working medium in the working medium transfer devices 30A, 30B, 30C, 30X, 30Y;
d) opening valves 40X, 41A, closing the valves 40A, 40B, 40C, 40Y, 40Z, 41B, 41C, 41X, 41Y, 41Z collecting the condensed working medium in the working medium transfer devices 30A, 30B, 30X, 30Y, 30Z;
e) opening valves 40B, 41Z, closing the valves 40A, 40C, 40X, 40Y, 40Z, 41A, 41B, 41C, 41X, 41Y collecting the condensed working medium in the working medium transfer devices 30A, 30B, 30C, 30Y, 30Z;
f) opening valves 40Y, 41C, closing the valves 40A, 40B, 40C, 40X, 40Z, 41A, 41B, 41X, 41Y, 41Z collecting the condensed working medium in the working medium transfer devices 30A, 30C, 30X, 30Y, 30Z;
d) repeating steps a) to f).

Thus advantageously a high efficiency of the thermal cycle may be achieved without pressure losses.

### BRIEF DESCRIPTION OF THE DRAWINGS

The invention as well as other features and advantages of it are described with respect to preferred embodiments with reference to the following figures.

FIG. 1 shows a schematic representation of the heat engine according to a first embodiment of the present invention;

FIG. 2a-2f show a schematic representation of the heat engine of FIG. 1 in different strokes of its operation process;

FIG. 3 shows a schematic representation of the heat engine according to a second embodiment of the present invention;

FIG. 4 shows a schematic representation of the heat engine according to a third embodiment of the present invention;

FIG. 5a-5f show a schematic representation of the heat engine of FIG. 4 in different cycles of its operation process;

FIG. 6 shows a schematic representation of the heat engine according to a fourth embodiment of the present invention;

FIG. 7 shows a schematic representation of the heat engine according to a fifth embodiment of the present invention;

FIG. 8a-8f show a schematic representation of the heat engine of FIG. 7 in different strokes of its operation process;

FIG. 9 shows a P-h-graph (pressure-enthalpy-diagram) of the working medium C₂H₂F₂, refrigerant 134a, of the operation process of the heat engine according to the present invention;

FIG. 10 shows a P-v-graph (pressure-volume-diagram) of the working medium C₂H₂F₂, refrigerant 134a, of the operation process of the heat engine according to the present invention with respect to the P-h-diagram shown in FIG. 6;

FIG. 11 shows a T-s-graph (pressure-enthropy-diagram) of the working medium C₂H₂F₂, refrigerant 134a, of the operation process of the heat engine according to the present invention with respect to the P-h-diagram shown in FIG. 6;

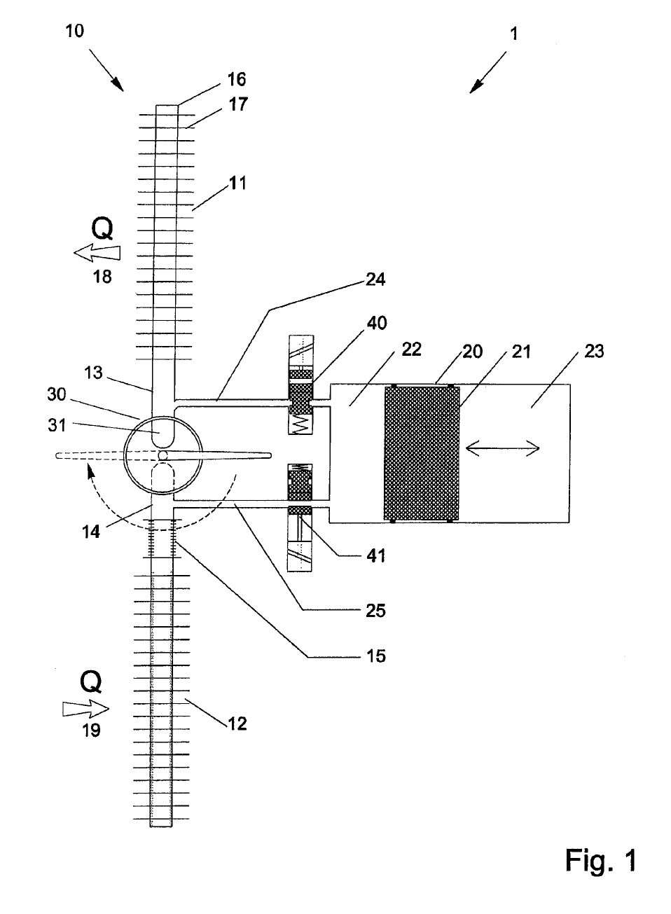

### DETAILED DESCRIPTION

### Heat Engine According to the First Embodiment

The heat engine 1 according to the first embodiment of the invention comprises a pair of heat exchangers 10, a cylinder 20, a working medium transfer device 30 and valve means 40, 41. The valve means consist of a first valve or condenser valve 40 and a second valve or evaporator valve 41. The pair of heat exchangers 10 consists of a first heat exchanger or condenser 11 (hereinafter condenser) and a second heat exchanger or evaporator 12 (hereinafter evaporator). The condenser 11 has a lower end part 13 and the evaporator has an upper end part 14.

The upper end part 14 of the evaporator 12 as well as the parts of the heat engine 1 described below may be insulated from the rest of the evaporator 12 by insulation 15. The insulation is made from a material that is suitable for the pressures and the mechanical stress but is a bad heat conductor. The insulation 15 is employed to minimize the heat conduction from evaporator 12 to the rest of heat engine 1. Further, it is contemplated to insulate the working engine and the conduits to the evaporator in order to prevent or at least minimize heat losses and the condensation of the gaseous working medium.

The condenser 11 and the evaporator 12 are each shown as tube 16 having fins 17. Nevertheless, it should be noted that other types of heat exchangers may also be employed. Further, it should be noted that, even though only one tube 16 is shown in the figures, each heat exchanger may comprise any number of tubes 16. The condenser 11 and the evaporator 12 may also have an appropriate design for a heat exchange by means of radiation.

Means for distributing the working medium over a large inner surface are arranged in the evaporator 12 in order to allow for an improved heat transfer to the working medium. The distribution means may comprise e.g. metal wool, metal filament or threads, surface structures or heat transfer fins or other surface structures that are arranged inside the evaporator. With fine surface structures the working medium is also distributed by means of capillary attraction which causes a better heat absorption from the wall of the evaporator 12.

The condenser 11 is surrounded by a flowing cooling medium 18. The cooling medium 18 may be gaseous or liquid. The evaporator 12 is surrounded by a flowing heating medium 19 that may be gaseous or liquid, as well.

The condenser 11 and the evaporator 12 are connected to the working medium transfer device 30. The working medium transfer device 30 comprises at least one working medium transport chamber 31 that may be selectively connected to the evaporator 12 and the condenser 11.

The working medium transfer device 30 may be positioned in at least three positions. In the first position the working medium transport chamber 31 is connected to the condenser 11 to receive the condensate and is disconnected from the evaporator 12. In the present embodiment, the working medium transport chamber 31 is connected to the condenser 11 at its lower end part 13. In the second position the working medium transport chamber 31 is disconnected from both the condenser 11 and the evaporator 12. In the third position the working medium transport chamber 31 is connected to the evaporator 12 to introduce the condensate, but is disconnected from the condenser 11. In the present embodiment the working medium transport chamber 31 is connected to the evaporator 12 at its upper end part 14. The working medium transfer device 30 may comprise an electric, pneumatic, hydraulic or other drive that may be actuated according to the operation process described below in more detail.

The working medium transfer device 30 may have any design. However, there must be no pressure exchange between the condenser 11 and the evaporator 12 during the transfer of the liquid condensed working medium. The working medium transfer device 30 simply has to transfer the condensate of the working medium formed in the condenser 11 into the evaporator 12 without establishing any direct connection between the condenser 11, and the evaporator 12.

The heat engine 1 further comprises the cylinder 20 in which a piston 21 is arranged. The cylinder 20 and the piston 21 define an operation chamber 22. The operation chamber 22 is connected to the condenser 11 via a conduit 24. Further, the operation chamber 22 is connected to the evaporator 12 via a conduit 25. Within the conduit 24, a valve 40 is arranged, which is able to open or close the connection between the operation chamber 22 and the condenser 11. Within the conduit 25, a valve 41 is arranged, which is able to open or close the connection between the operation chamber 22 and the evaporator 12. The valves 40, 41 may comprise an electric, pneumatic, hydraulic or other drive that may be activated by the operation process described below in more detail.

### Operation of the Heat Engine According to the First Embodiment

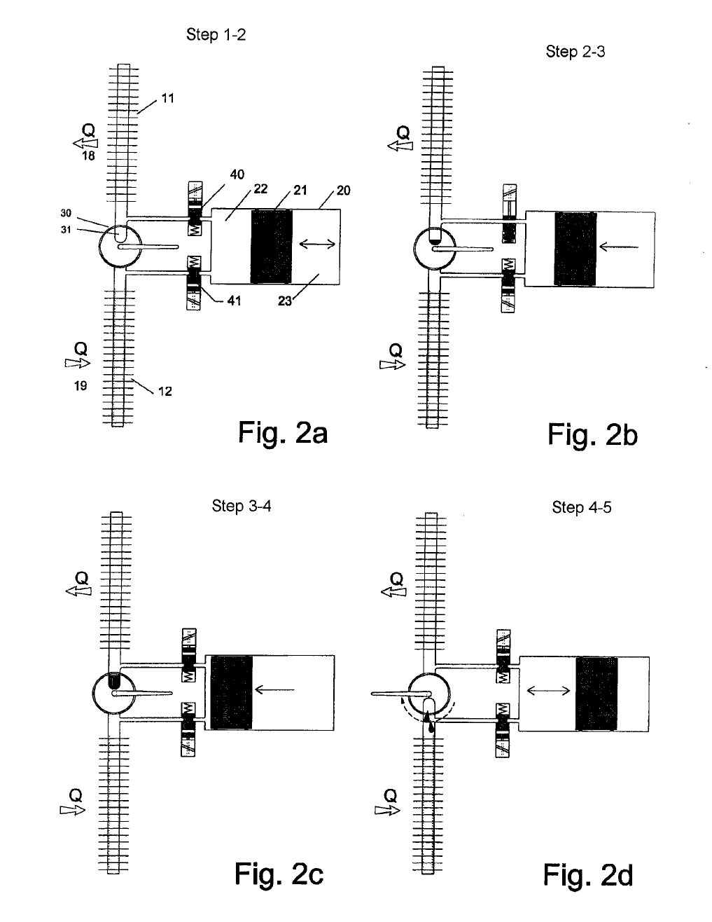

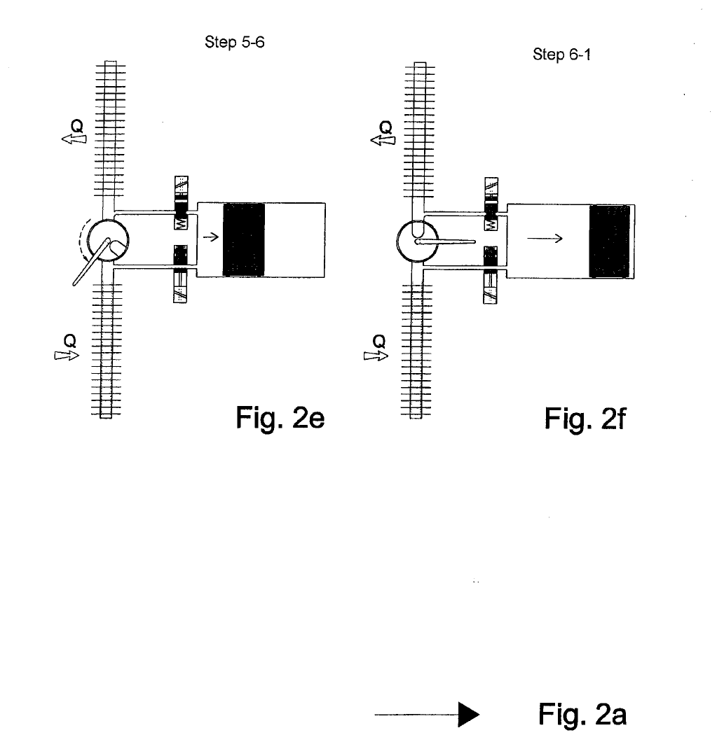

The operation of the first embodiment of heat engine 1 takes place with the following changes of state of the working medium in a closed cycle process. During operation, a cooling medium flows around condenser 11, whereas evaporator 12 simultaneously experiences a heat addition by the heating medium. The changes of state of the cycle process proceed in the following sequence (FIG. 2a-2f):

1. Isochoric Heat Extraction (Steps 1-2 in FIG. 9, FIG. 2a)

The working medium is cooled at constant volume to the lower temperature level in condenser 11. Valve 40 is closed, and the working medium transport chamber 31 of the working medium transfer device 30 is connected to the evaporator 11. Valve 41 is closed.

2. Isothermal Compression (Steps 2-3 in FIG. 9, FIG. 2b)

Valve 40 between cylinder 20 and condenser 11 is open, and more vapour of the working medium flows from cylinder 20 into condenser 11. This takes place partly because of the low or negative pressure in condenser 11 and partly because of the pressure on piston 21 in cylinder 20 from the opposite (right) side (see also second and third embodiment). Due to the continuous cooling by the cooling medium, more vapour of the working medium is liquefied and is collected in the working medium transport chamber 31. An isothermal compression takes place as the inflowing warm vapour contracts because of cooling in the condenser 11. As the gaseous working medium flows from cylinder 20 into condenser 11, further heat is extracted from condenser 11. Valve 41 is closed.

3. Isobaric Condensation (Steps 3-4 in FIG. 9, FIG. 2c)

Once the condensation temperature is reached, the working medium liquefies at constant pressure and temperature. Due to the continuous cooling additional vapour of the working medium is condensed. The vapour condenses until the pressure in the condenser 11 reaches the vapour pressure at the condensation temperature. The vapour of the working medium does not fully condense but is compressed with concurrent heat extraction. The condensed liquid working medium is collected in the working medium transport chamber 31. Valve 41 is closed.

4. Isochoric Heat Input (Steps 4-5 in FIG. 9, FIG. 2d)

Valve 40 is closed. By actuating the working medium transfer device 30, the condensate of the working medium flows into the evaporator 12. Due to the preceding condensation of the working medium in the condenser 11 a substantial quantity of condensate was present in the working medium transport chamber 31. This condensate gets into the hot evaporator 12, the evaporator's temperature (upper temperature level) being higher than the boiling point of the working medium. Part of the working medium is evaporated and creates pressure in the evaporator 12. Valve 41 arranged in direction to the working cylinder 20 remains closed during the heating. Therefore this change of state takes place at constant volume. The evaporation of the working medium takes place until the vapour pressure at the upper temperature level is reached.

5. Isobaric Evaporation (Steps 6-1 in FIG. 9, FIG. 2f)

Valve 41 is opened. Due to the pressure in the evaporator 12, the working medium flows out of the evaporator 12 and into the working cylinder 20, while additional heat is fed into the evaporator 12 from outside. Due to the increase of volume and the continuous heat input, another part of the condensate evaporates at constant pressure.

### 6. Isothermal Expansion

After the condensate is fully evaporated, the gaseous working medium further expands, while additional heat is fed into the evaporator 12. An isothermal expansion takes place. Valve 41 closes. After the expansion, the working medium transfer device 30 is returned to its initial position to gather condensate accumulating in the condenser.

In this cycle process, condenser 11 and evaporator 12 are always used as a pair. The condenser 11 and evaporator 12 of a pair of heat exchangers 10 are connected to each other via the working medium transfer device 30 in such a way that the liquid condensate of the working medium generated in the condensation in the condenser 11 is transferred to the evaporator 12 by means of the working medium transfer device 30 without pressure equalization. Each condenser 11 is always connected to an evaporator 12 with similar or larger heat capacity.

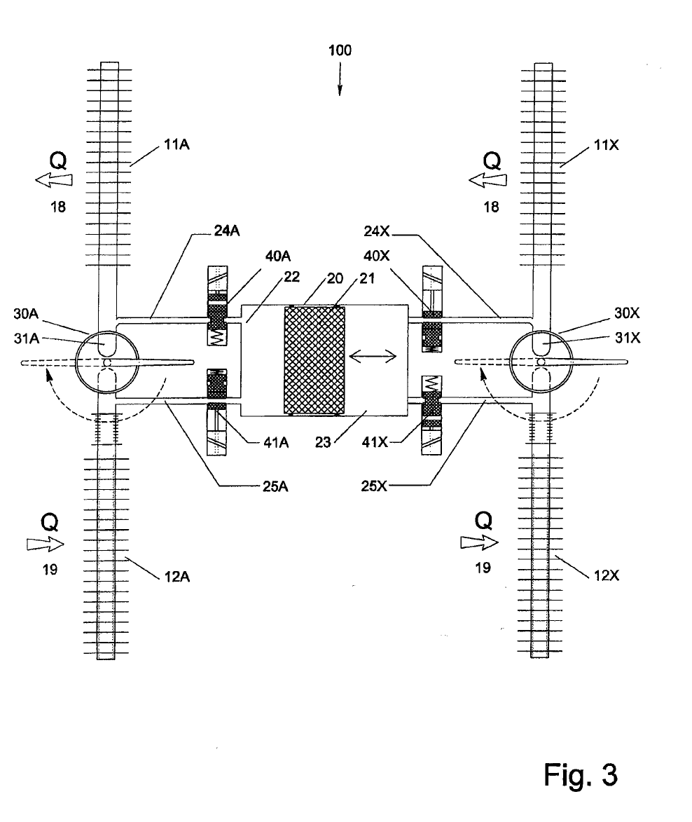

In this invention the above described cycle process may take place in different pairs of heat exchangers 10 simultaneously but chronologically offset. The design as well as the mode of operation of a heat engine 100 having multiple heat exchangers will be explained with reference to FIG. 3.

A stroke corresponds to half a piston period. A piston period (back and forth) corresponds to two cycles.

### Heat Engine According to the Second Embodiment

FIG. 3 shows a schematic representation of another embodiment of a heat engine 100 according to the present invention. The heat engine 100 according to the second embodiment is constructed of similar parts as heat engine 1. Therefore, corresponding parts are labelled with the same reference numbers. For parts on the left side (FIG. 3) of cylinder 20 an “A” is attached to the reference number. For parts on the right side (FIG. 3) of cylinder 20 an “X” is attached to the reference number. Furthermore, corresponding parts are not described in detail.

Heat engine 100 according to the second embodiment of the invention comprises two pairs of heat exchangers 10A, 10X, a cylinder 20, two working medium transfer devices 30A, 30X and valves 40A, 41A and 40X, 41X. Pairs of heat exchangers 10A, 10X each comprise a first heat exchanger or condenser 11A, 11X (hereinafter condenser) and a second heat exchanger or evaporator 12A, 12X (hereinafter evaporator). As in the first embodiment, each condenser 11A, 11X has a lower end part 13 and each evaporator 12A, 12X has an upper end part 14.

The upper end part 14 as well as the parts of the heat engine 100 described below may be insulated from the rest of the evaporator 12A, 12X by insulation 15, respectively. The insulation is made from a material, which is suitable for the pressures and mechanical stresses but is a bad heat conductor at the same time. Insulation 15 is employed to minimize the heat transfer from the evaporators 12A, 12X to the rest of the heat engine 100.

The condenser 11 and the evaporator 12 are each shown as a tube 16 having fins 17. But it should be noted, that other types of heat exchangers may also be employed. Further, it should be noted that, even though only one tube 16 is shown in the figures, each heat exchanger may comprise any number of tubes 16. The pairs of heat exchangers 10A, 10X may also have an appropriate design for a heat exchange by means of radiation.

In the evaporators 12A, 12X, means for distributing the working medium over a large inner surface are arranged to allow for an improved heat transfer to the working medium. The distribution means may comprise e.g. metal wool, metal filament or threads, surface structures or heat transfer fins or other surface structures arranged inside the evaporator. With fine surface structures, the working medium is also distributed by means of capillary attraction which causes a better heat absorption from the wall of the evaporator 12.

The condensers 11A, 11X are surrounded by a flowing cooling medium 18. The cooling medium 18 may be gaseous or liquid. The evaporators 12A, 12X are surrounded by a flowing heating medium 19, which may be gaseous or liquid as well.

Each the lower end parts 13 of the condensers 11A, 11X and the upper end parts 14 of the evaporators 12A, 12X are connected by means of a working medium transfer device 30A, 30X. The respective working medium transfer devices 30A, 30X comprise at least one working medium transport chamber 31 that may selectively be connected to the respective evaporator 12A, 12X and the respective condenser 11A, 11X.

As in the first embodiment, the working medium transfer devices 30A, 30X may be positioned in at least three positions. In the first position, the working medium transport chamber 31 is connected to the lower end part 13 of the condenser. In the second position, the working medium transport chamber 31 is disconnected from the condenser as well as from the evaporator. In the third position, the working medium transport chamber 31 is connected to the upper end part 14 of the evaporator. The working medium transfer device 30 may comprise an electric, pneumatic, hydraulic or other drive that may be actuated according to the operation process described below in more detail.

The heat engine 100 further comprises cylinder 20, in which piston 21 is arranged. Contrary to the first embodiment, cylinder 20 and piston 21 define two operation chambers 22, 23. The operation chambers are located to the right and the left (in FIG. 3) of piston 21.

In the second embodiment, the first operation chamber 22 is connected to the first pair of heat exchangers 10A via conduits 24A, 24X, 25A, 25X, and the second operation chamber 23 is connected to the second pair of heat exchangers 10X. That is, the operation chambers 22, 23 are each connected to the condenser of the respective pair of heat exchangers 10A, 10X via a conduit 24A, 24X. Furthermore, the operation chambers 22, 23 are connected to the evaporator of the respective pair of heat exchangers 10A, 10C via a conduit 25A, 25X.

A valve 40A, 40X is arranged in the conduits 24A, 24X, respectively, the valve 40A, 40X being able to open or close the connection between the operation chamber 22, 23 and the corresponding condenser. In conduits 25A, 25X, a valve 41A, 41X is arranged, which is able to open or close the connection between the operation chamber 22, 23 and the evaporator. Valves 40A, 40X, 41A, 41X may comprise an electric, pneumatic, hydraulic or other drive that may be activated by the operation process described below in more detail.

### Operation of Heat Engine According to the Second Embodiment

The operation of heat engine 100 according to the second embodiment is based on the same principle as the operation of the first embodiment. Therefore, the whole process will not be described again.

As the cylinder 20 defines two operation chambers 22, 23 in the second embodiment, chronologically displaced cycles take place in the first (left) pair of heat exchangers 10A and in the second (right) pair of heat exchangers 10X, the cycles reinforcing each other.

For example, piston 21 is pushed to the left during stroke 5 (isobaric evaporation) and 6 (isothermal expansion) of the right pair of heat exchangers 10X. Accordingly, strokes 2 and 3 take place in the left pair of heat exchangers 10A that pull or suck piston 21 to the left.

By means of cooling the left condenser 11A, the enclosed gaseous working medium is cooled to the lower temperature level, and the pressure inside the condenser 11A maximally corresponds to the vapour pressure of the working medium at the temperature of the cooling medium. Likewise, the gaseous working medium enclosed in the right evaporator 12X is heated by the continuing heating of the evaporator 12X.

Piston 21 is located at the right hand side. Valve 40A located at condenser 11A and valve 41X located at the evaporator 12X are opened at the same time. The lower pressure in the left evaporator 11A and the higher pressure in the right condenser 12X act upon the piston 21 via the respective conduits 24A, 25X. By means of the pressure difference that now exists on both sides of piston 21, piston 21 is pushed leftwards.

Once piston 21 reaches its end position on the left hand side, valves 40A and 41X are closed.

Furthermore, respective cycle processes take place in the left and right pairs of heat exchangers 10A, 10X according to the above described sequence (see first embodiment).

### Heat Engine According to Third Embodiment

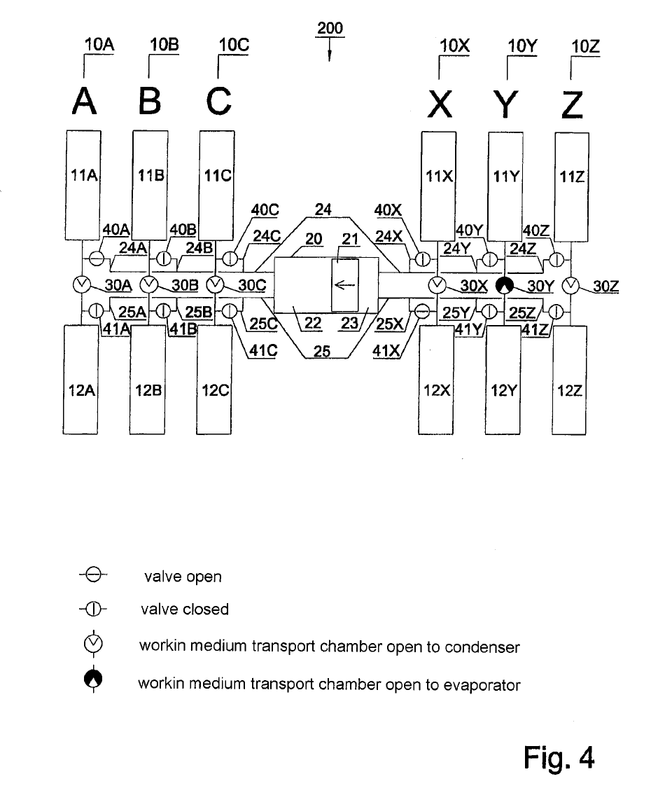

FIG. 4 shows a schematic representation of a third embodiment of a heat engine 200 according to the present invention. Similar to the second embodiment, cylinder 20 defines two operation chambers 22, 23. In the third embodiment, the left operation chamber 22 is connected to three pairs of heat exchangers 10X, 10Y, 10Z. The side of the cylinder 20 on which the pairs of heat exchangers 10A, 10B and 10C are arranged is hereinafter referred to as “left side”, the side on which the pairs of heat exchangers 10X, 10Y and 10Z are arranged is referred to as “right side”.

Heat engine 200 according to the third embodiment is based on similar parts as heat engine 100. Therefore, corresponding parts are labelled with the same reference numbers. For parts on the left side (FIG. 4) of cylinder 20 reference numbers “A”, “B” or “C” are attached to the reference numbers (according to the respective pair of heat exchangers). For parts on the right side (FIG. 4) of cylinder 20 reference numbers “X”, “Y” or “Z” are attached to the reference numbers. Furthermore, corresponding parts will not be described in detail.

Heat engine 200 according to the third embodiment of the invention comprises six pairs of heat exchangers 10A, 10B, 10C, 10X, 10Y, 10Z, a cylinder 20, six working medium transfer devices 30A, 10B, 30C, 30X, 30Y, 30Z and valves 40A, 40B, 40C, 40X, 40Y, 40Z, 41A, 41B, 41C, 41X, 41Y, 41Z. The pairs of heat exchangers 10-10Z each consist of a first heat exchanger or condenser 11A-11Z (hereinafter condenser) and a second heat exchanger or evaporator 12A-12Z (hereinafter evaporator). As in the first embodiment, each condenser 11A-11Z has a lower end part 13 and each evaporator 12A-12Z has an upper end part 14.

It should be noted that it is generally possible to implement a heat engine having more or less pairs of heat exchangers. But the number of pairs of heat exchangers should be an even number.

The upper end part 14 as well as the parts of the heat engine 200 described below may be insulated from the rest of the evaporator 12A-12Z by insulation 15, respectively. The insulation is made from a material that is suitable for the pressures and mechanical stresses but is a bad heat conductor at the same time. Insulation 15 is employed to minimize the heat transfer from the evaporators 12A-12Z to the rest of the heat engine 200.

Each the condensers 11A-11Z and the evaporators 12A-12Z are shown as a tube 16 having fins 17. But it should be noted that other types of heat exchangers may also be employed. Further it should be noted that, even though only one tube 16 is shown in the figures, each heat exchanger may comprise any number of tubes 16. The pairs of heat exchangers 10A-10Z may also have an appropriate design for a heat exchange by means of radiation.

In evaporators 12A-12Z, means for distributing the working medium over a large inner surface are arranged to allow for an improved heat transfer to the working medium. The distribution means may comprise e.g. metal wool, metal filament or threads, surface structures or heat transfer fins or other surface structures, which are arranged inside the evaporator. With fine surface structures the working medium is also distributed by means of capillary attraction which causes a better heat absorption from the wall of the evaporator 12.

The condensers 11A-11Z are surrounded by a flowing cooling medium 18. The cooling medium 18 may be gaseous or liquid. The evaporators 12A-12Z are surrounded by a flowing heating medium 19 that may be gaseous or liquid as well.

As in the first embodiment, the working medium transfer devices 30A-30Z may be positioned in at least three positions. In the first position, the working medium transport chamber 31A-31Z is connected to the respective condenser 11A-11Z, but is disconnected from the evaporators 12A-12Z. In the second position, the working medium transport chamber 31A-31Z is disconnected from the condensers 11A-11Z as well as from the evaporators 12A-12Z. In the third position, the working medium transport chamber 31A-31Z is connected to evaporator 12A-12Z, but is disconnected from condenser 11A-11Z. The working medium transfer device 30A-30Z may comprise an electric, pneumatic, hydraulic or other drive that may be actuated according to the operation process described below in more detail.

The heat engine 200 further comprises cylinder 20, in which piston 21 is arranged. Similarly to the second embodiment cylinder 20 and piston 21 define two operation chambers 22, 23. The operation chambers 22, 23 are located to the right and the left (in FIG. 4) of piston 21.

In the third embodiment, the first operation chamber 22 is connected to pairs of heat exchangers 10A, 10B, 10C (left group), and the second operation chamber 23 is connected to pairs of heat exchangers 10X, 10Y, 10Z (right group).

A conduit 24 runs from the operation chambers 22, 23 in direction of the evaporators 11A-11Z of the right and left groups of pairs of heat exchangers respectively. Furthermore a conduit 25 runs from the operation chambers 22, 23 in direction of the evaporators 12A-12Z of the right and left groups of pairs of heat exchangers, respectively. The condensers 11A-11Z are connected to the respective left and right conduits 24 via junction conduits 24A-24Z. The evaporators 12A-12Z are connected to the respective left and right conduits 25 via junction conduits 25A-25Z. The conduits 24, 25 are therefore designed as manifolds.

In junction conduits 24A-24Z, a valve 40A-40Z is arranged respectively that is able to open or close the connection between the operation chamber 22, 23 and the corresponding condenser. In junction conduits 25A-25Z, a valve 41A-41Z is arranged that is able to open or close the connection between the operation chamber 22, 23 and the evaporator. Valves 40A-40Z and 41A-41Z may comprise an electric, pneumatic, hydraulic or other drive that may be activated by the operation process described below in more detail.

Another alternative for connecting condensers 11A-11Z and evaporators 12A-12Z to the operation chambers 22, 23 is also contemplated: condenser 11A-11Z may be connected to the respective operation chamber directly via a separate junction conduit 24A-24Z. Similarly, the evaporators 12A-12Z may be connected to the respective operation chamber directly via a separate junction conduit 25A-25Z. Valves 40A-40Z and 41A-41Z would then be arranged directly in the junction conduits 24A-24Z and 25A-25Z, respectively.

### Operation of Heat Engine According to Third Embodiment

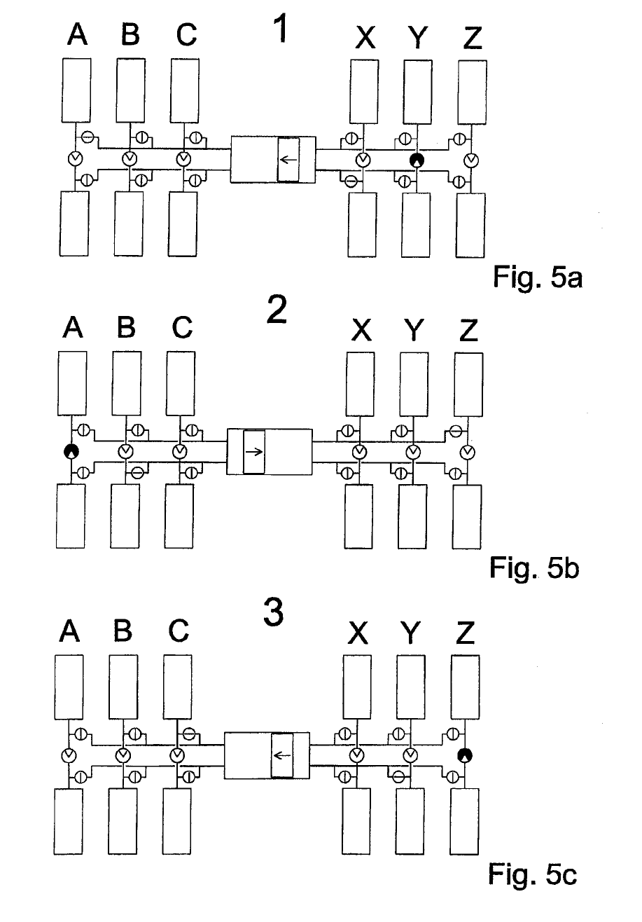

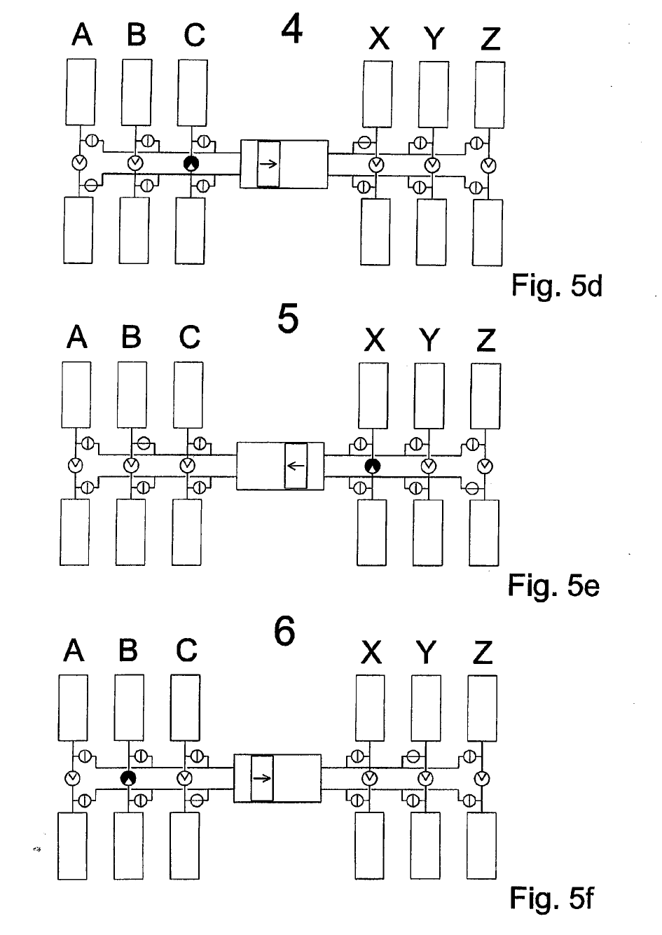

FIGS. 5a to 5g schematically show the cycle process of heat engine 200 of FIG. 4 having six pairs of heat exchangers. It should be noted that an adapted operation sequence may also be executed by more or less pairs of heat exchangers. The number of pairs of heat exchangers should be an even number. During operation, a cooling medium flows around the condensers 11A-11Z, while the evaporators 12A-12Z experience a heat input by a heating medium at the same time.

The operation of the third embodiment of the heat engine proceeds with the same changes of state of the working medium in the above described closed cycle process as in the preceding embodiments. Therefore in the following, the sequence of the switching operations of valves 40A-40Z, 41A-41Z and the working medium transfer devices 30A-30Z will mainly be described. In order to avoid an unnecessary long description, the changes of state in each pair of heat exchangers 10A-10Z will only be mentioned if such mentioning simplifies the description.

The changes of state or strokes of the cycle process proceed in the following sequence:

Stroke 1 (FIG. 5a)

Opening valves 40A, 41X, closing valves 40B, 40C, 40X, 40Y, 40Z, 41A, 41B, 41C, 41Y, 41Z, collecting condensed working medium in the working medium transfer devices 30A, 30B, 30C, 30X, 30Z.

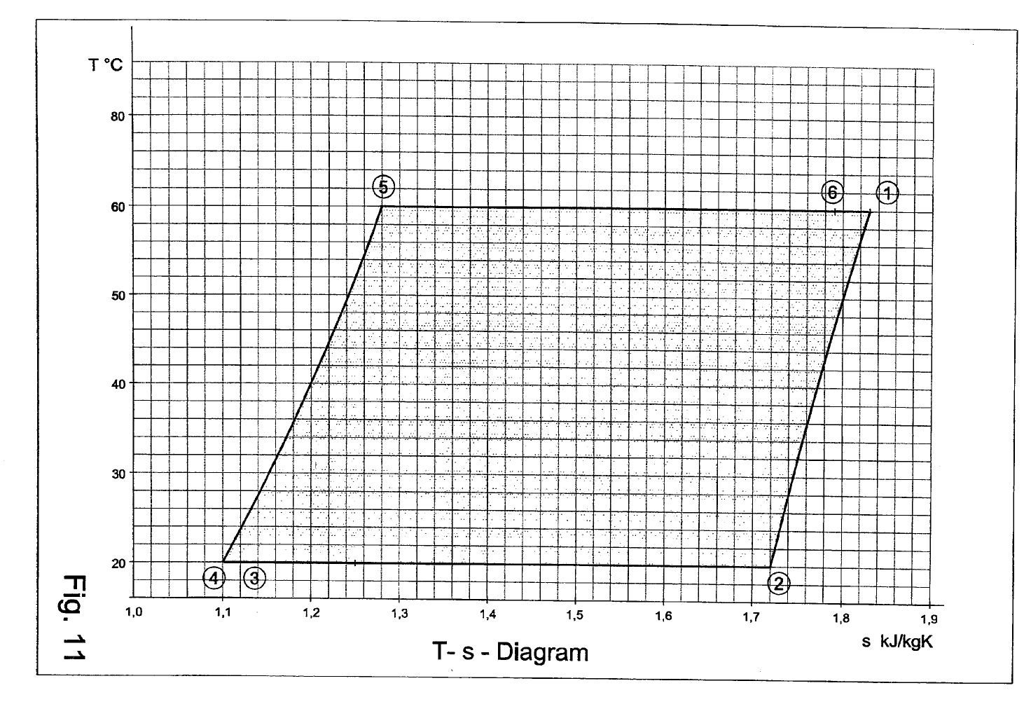

The working medium is cooled by cooling the condenser at constant a volume in the condensers 11B, 11C, 11X, 11Y, 11Z to the lower temperature level. The working medium is heated by heating the evaporators 12A, 12B, 12C, 12Y, 12Z to the upper temperature level (FIGS. 9-11). The working medium transport chambers 31A, 31B, 31C, 31X, 31Z of the working medium transfer devices are connected to the respective condensers 11A, 11B, 11C, 11X, 11Z. The pressure in the condensers maximally corresponds to the vapor pressure of the working medium at the temperature of the cooling medium.

The piston 21 is located at the right hand side. The pressure in evaporator 12X is directed to the right operation chamber 23. The lower pressure generated by isochoric heat extraction in condenser 12A is connected to the left operation chamber 22. Due to the pressure difference that now exists on both sides of the piston, the piston is pushed to the left.

While the piston 21 is moving, the condensate is transferred from the condenser 11Y to the evaporator 12Y via the working medium transfer device 31Y. Once piston 21 has reached its end position on the left side, valves 40A and 41X are closed and stroke 1 is finished.

Stroke 2 (FIG. 5b)

Opening valves 41B, 40Z, closing valves 40A, 40B, 40C, 40X, 40Y, 41A, 41C, 41Y, 41Y, 41Z, collecting the condensed working medium in the working medium transfer devices 30B, 30C, 30X, 30Y, 30Z.

The working medium is cooled by cooling of the condenser at constant volume in the condensers 11A, 11B, 11C, 11X, 11Y to the lower temperature level. The working medium is heated by heating of the evaporators 12A, 12C, 12X, 12Y, 12Z to the upper temperature level (FIGS. 9-11). The working medium transport chambers 31B, 31C, 31X, 31Y, 31Z of the working medium transfer devices are connected to the respective condensers 11B, 11C, 11X, 11Y, 11Z. The pressure in the condensers maximally corresponds to the vapor pressure of the working medium at the temperature of the cooling medium.

The piston 21 is located at the left hand side. The pressure in evaporator 12B is directed to the left operation chamber 22. The lower pressure generated by isochoric heat extraction in condenser 12Z is connected to the right operation chamber 23. Due to the pressure difference, which now exists on both sides of the piston, the piston is pushed to the right.

While the piston 21 is moving, the condensate is transferred from the condenser 11A to the evaporator 12A via the working medium transfer device 31A. Once piston 21 has reached its end position on the right side, valves 40Z and 41B are closed and stroke 2 is finished.

Stroke 3 (FIG. 5c)

Opening valves 40C, 41Y, closing valves 40A, 40B, 40X, 40Y, 40Z, 41A, 41B, 41C, 41X, 41Z, collecting the condensed working medium in the working medium transfer devices 30A, 30B, 30C, 30X, 30Y.

The working medium is cooled by the cooling of the condenser at constant volume in the condensers 11A, 11B, 11X, 11Y, 11Z to the lower temperature level. The working medium is heated by the heating of the evaporators 12A, 12B, 12C, 12X, 12Z to the upper temperature level (FIGS. 9-11). The working medium transport chambers 31A, 31B, 31C, 31X, 31Y of the working medium transfer devices are connected to the respective condensers 11A, 11B, 11C, 11X, 11Y. The pressure in the condensers maximally corresponds to the vapor pressure of the working medium at the temperature of the cooling medium.

The piston 21 is located at the left hand side. The pressure in evaporator 12Y is directed to the right operation chamber 23. The lower pressure generated by isochoric heat extraction in condenser 12C is connected to the left operation chamber 22. Due to the pressure difference, which now exists on both sides of the piston, the piston is pushed to the left.

While the piston 21 is moving, the condensate is transferred from the condenser 11Z to the evaporator 12Z via the working medium transfer device 31Z. Once piston 21 has reached its end position on the left side, valves 40C and 41Y are closed and stroke 3 is finished.

Stroke 4 (FIG. 5d)

Opening valves 40X, 41A, closing valves 40A, 40B, 40C, 40Y, 40Z, 41B, 41C, 41X, 41Y, 41Z, collecting the condensed working medium in the working medium transfer devices 30A, 30B, 30X, 30Y, 30Z.

The working medium is cooled by the cooling of the condenser at constant volume in the condensers 11A, 11B, 11C, 11Y, 11Z to the lower temperature level. The working medium is heated by the heating of the evaporators 12B, 12C, 12X, 12Y, 12Z to the upper temperature level (FIGS. 9-11). The working medium transport chambers 31A, 31B, 31X, 31Y, 31Z of the working medium transfer devices are connected to the respective condensers 11A, 11B, 11X, 11Y, 11Z. The pressure in the condensers maximally corresponds to the vapor pressure of the working medium at the temperature of the cooling medium.

The piston 21 is located at the left hand side. The pressure in evaporator 12A is directed to the left operation chamber 22. The lower pressure generated by isochoric heat extraction in condenser 12X is connected to the right operation chamber 23. Due to the pressure difference, which now exists on both sides of the piston, the piston is pushed to the right.

While the piston 21 is moving, the condensate is transferred from the condenser 11C to the evaporator 12C via the working medium transfer device 31C. Once piston 21 has reached its end position on the right side, valves 40X and 41A are closed and stroke 4 is finished.

Stroke 5 (FIG. 5e)

Opening valves 40B, 41Z, closing valves 40A, 40C, 40X, 40Y, 40Z, 41A, 41B, 41C, 41X, 41Y, collecting the condensed working medium in the working medium transfer devices 30A, 30B, 30C, 30Y, 30Z.

The working medium is cooled by the cooling of the condenser at constant volume in the condensers 11A, 11C, 11X, 11Y, 11Z to the lower temperature level. The working medium is heated by the heating of the evaporators 12A, 12B, 12C, 12X, 12Y to the upper temperature level (FIGS. 9-11). The working medium transport chambers 31A, 31B, 31C, 31Y, 31Z of the working medium transfer devices are connected to the respective condensers 11A, 11B, 11C, 11Y, 11Z. The pressure in the condensers maximally corresponds to the vapor pressure of the working medium at the temperature of the cooling medium.

The piston 21 is located at the right hand side. The pressure in evaporator 12Z is directed to the right operation chamber 23. The lower pressure generated by isochoric heat extraction in condenser 12B is connected to the left operation chamber 22. Due to the pressure difference, which now exists on both sides of the piston, the piston is pushed to the right.

While the piston 21 is moving, the condensate is transferred from the condenser 11X to the evaporator 12X via the working medium transfer device 31X. Once piston 21 has reached its end position on the left side, valves 40B and 41Z are closed and stroke 5 is finished.

Stroke 6 (FIG. 5f)

Opening valves 40Y, 41C, closing valves 40A, 40B, 40C, 40X, 40Z, 41A, 41B, 41X, 41Y, 41Z, collecting the condensed working medium in the working medium transfer devices 30A, 30C, 30X, 30Y, 30Z.

The working medium is cooled by the cooling of the condenser at constant volume in the condensers 11A, 11B, 11C, 11X, 11Z to the lower temperature level. The working medium is heated by the heating of the evaporators 12A, 12B, 12X, 12Y, 12Z to the upper temperature level (FIGS. 9-11). The working medium transport chambers 31A, 31C, 31X, 31Y, 31Z of the working medium transfer devices are connected to the respective condensers 11A, 11C, 11X, 11Y, 11Z. The pressure in the condensers maximally corresponds to the vapor pressure of the working medium at the temperature of the cooling medium.

The piston 21 is located at the left hand side. The pressure in evaporator 12C is directed to the left operation chamber 22. The lower pressure generated by isochoric heat extraction in condenser 12Y is connected to the right operation chamber 23. Due to the pressure difference, which now exists on both sides of the piston, the piston is pushed to the right.

While the piston 21 is moving, the condensate is transferred from the condenser 11B to the evaporator 12B via the working medium transfer device 31B. Once piston 21 has reached its end position on the right side, valves 40Y and 41CA are closed and stroke 6 is finished.

Thereafter, strokes 1 to 6 are executed again.

### Heat Engine According to Fourth Embodiment

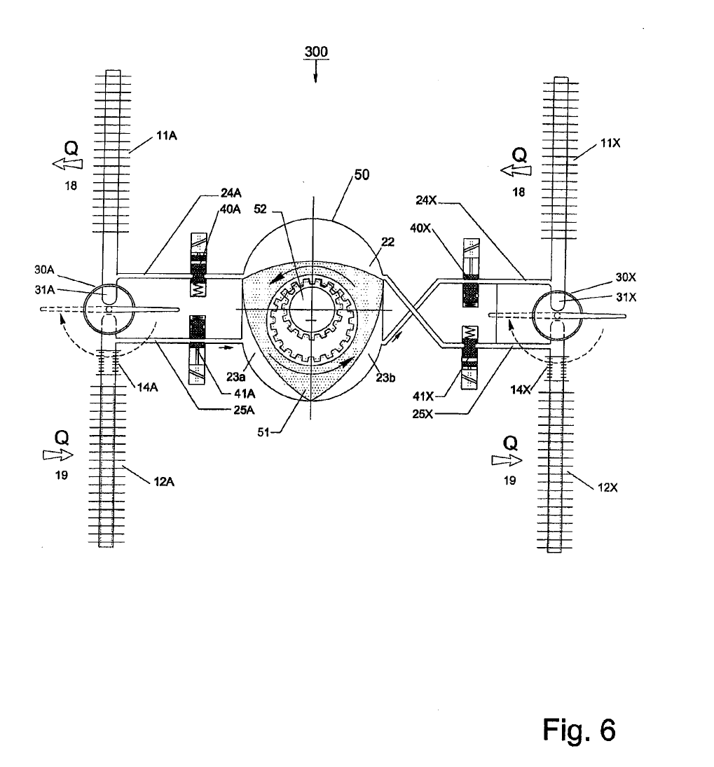

FIG. 6 shows a schematic representation of a fourth embodiment of a heat engine 300 according to the present invention. Contrary to the third embodiment, a rotary piston engine is provided instead of cylinder 20.

The body 50 of the rotary piston engine and the triangular rotor 51 define three operation chambers. Due to the odd number of operation chambers, the distribution of the chambers with respect to the connections of the respective conduits is changing. Thus, two operation chambers 22, 23 are defined, wherein one of the operation chambers is divided in two separate chambers. The divided operation chamber is denoted with suffixes “a” and “b”. The operation chambers are therefore chambers 23, 22a and 22b or the operation chambers are chambers 22, 23a and 23b. In FIG. 6 the “top” operation chamber is denoted 22 and the “bottom” operation chamber is denoted 23.

In the fourth embodiment the top operation chamber 22 is connected to the condenser 11A and the evaporator 12X. The bottom operation chamber 23b is connected to the condenser 11X, and the operation chamber 23a is connected to the evaporator 12A.

The rest of heat engine 300 according to the fourth embodiment is formed of similar parts as heat engine 200. Therefore, the same reference numbers will be used for corresponding parts. For the parts on the left side (of FIG. 6) of the rotary piston engine 50, “A” is added to the reference number, and for the parts on the right side (of FIG. 6) of cylinder 20 accordingly “X” is added to the reference number. Furthermore, corresponding parts will not be described in detail.

Heat engine 300 according to the fourth embodiment of the invention comprises two pairs of heat exchangers 10A and 10X, a rotary piston engine 50, two working medium transfer devices 30A and 30X and four valves 40A, 40X, 41A and 41X. The pairs of heat exchangers 10A and 10X each consist of a first heat exchanger or condenser 11A and 11X (hereinafter condenser) and a second heat exchanger or evaporator 12A and 12X (hereinafter evaporator), respectively. As in the first embodiment each condenser 11A, 11X comprises a lower end part 13, and each evaporator 12A, 12X comprises an upper end part 14.

The upper end part 14 of each evaporator as well as the parts of heat engine 300 described below may be insulated from the rest of the evaporators 12A-12X by insulation 14A and 14X, respectively. The insulation is made from a material that is suitable for the pressures and mechanical stresses but is a bad heat conductor at the same time. Insulation 14A, 14X is employed to minimize the heat transfer from the evaporators 12A, 12X to the rest of heat engine 300.

The condensers 11A and 11X and the evaporators 12A and 12X are each shown as tube 16 having fins 17. It should be noted that other types of heat exchangers may also be employed. Further, it should be noted that, even though only one tube 16 is shown in the figures, each heat exchanger may comprise any number of tubes 16. The pairs of heat exchangers 10A and 10X may also have an appropriate design for a heat exchange by means of radiation.

In evaporators 12A and 12X, means for distributing the working medium over a large inner surface are arranged to allow for an improved heat transfer to the working medium. The distribution means may comprise e.g. metal wool, metal filament or threads, surface structures or heat transfer fins or other surface structures, that are arranged inside the evaporator and which, by means of capillary attraction, distribute the liquid working medium uniformly over the inner surface.

The condensers 11A and 11X are surrounded by a flowing cooling medium 18. The cooling medium 18 may be gaseous or liquid. The evaporators 12A and 12X are surrounded by a flowing heating medium 19 that may be gaseous or liquid as well. The heating medium 19 may also be gaseous or liquid. Each the lower end parts 13 of the condensers 11A and 11X and the upper end parts 14 of the evaporators 12A and 12X are connected by means of a working medium transfer device 30A and 30X. The respective working medium transfer devices 30A and 30X comprise at least one working medium transport chamber 31 that may selectively be connected to the respective evaporator 12A and 12X and the respective condenser 11A and 11X.

As in the previously described embodiments the working medium transfer devices 30A and 30X can take at least three positions. In the first position, the working medium transport chamber 31 is connected to the lower end part 13 of the condenser. In the second position, the working medium transport chamber 31 is disconnected from the condenser as well as the evaporator. In the third position, the working medium transport chamber 31 is connected to the upper end part 14 of the evaporator. The working medium transfer device 30A and 30X may comprise an electric, pneumatic, hydraulic or other drive that may be actuated according to the operation process described below in more detail.

### Operation of the Heat Engine According to the Fourth Embodiment

The operation of heat engine 300 according to the fourth embodiment differs from that of the previously described embodiments. Therefore the process is described in more detail.

As the rotary piston engine defines the three operation chambers 23, 22a and 22b or 22, 23a and 23b in the fourth embodiment, chronologically displaced cycle processes take place in the first (left) pair of heat exchangers 10A and in the second (right) pair of heat exchangers 10X which reinforce each other.

FIG. 6 is taken as a starting point for the following description. The rotary piston is located in such a way that one of the triangle corners 51A points vertically downwards, whereas the corners 51B (right) and 51C (left) are situated at the connection ports of the conduits 25X (right) and 24A (left).

In the present illustration of FIG. 6, the rotary piston 51 is pushed counter-clockwise to the right due to the eccentricity of the drive shaft 53 during stroke 5 (isobaric evaporation) and 6 (isothermal expansion) of the left evaporator 12A which generate a high pressure in the operation chamber 23a. Correspondingly, strokes 2 (isothermal compression) and 3 (isobaric condensation) take place in the right condenser 11X, which generate a low pressure in the operation chamber 23b and pull the rotary piston 51 counter-clockwise to the right.

In a further counter-clockwise rotation away from the position shown in FIG. 6, the connections of the conduits 24X and 25X are connected by the same operation chamber. Valve 41X is closed at that time until the next corner of the rotary piston 51A separates these two connections into two different operation chambers. Immediately after the rotary piston tip 51A has passed over the connection of the conduit 24X on the right side (of FIG. 6) valve 40X closes, so that no overflow takes place between the connection ports of the conduits 40X and 41X and therefore between the condenser 11X and the evaporator 12X during the subsequent opening of a common operation chamber.

On the left side of the rotary piston engine, the piston tip 51C moves away from the connection of conduit 24A towards the connection port of conduit 25A. Valve 41A closes before the piston tip runs over the connection port of conduit 25A in order to prevent the emerging common operation chamber from generating a short-circuit or overflow between condenser 11A and evaporator 12A.

Due to the cooling of the left condenser 11A, the enclosed gaseous working medium is cooled to the lower temperature level. The pressure within condenser 11A corresponds maximally to the vapour pressure of the working medium at the temperature of the cooling medium. In the same way the gaseous working medium enclosed in the right evaporator 12X is heated up by the continued heating of evaporator 12X.

Now the piston 51 cooperating with corner 51B defines two operation chambers 22a and 22b (besides a third operation chamber 23). At the same time the connection of condenser 11A is located in the left chamber 22b, and the connection of evaporator 12X is located in the right chamber 22a. Valve 40A at condenser 11A and valve 41X at evaporator 12X are closed.

The low pressure in the left condenser 11A and the high pressure in the right evaporator 12X act upon the rotary piston 51 that is now eccentrically supported to the top via the respective conduits 24A, 25X. By means of the pressure difference that is now present in the operation chambers 22a and 22b, the rotary piston 51 is further rotated counter-clockwise. During this sequence the valves 41A and 40X remain closed.

Before the rotary piston corner 51B crosses over the connection of the conduit 24A, valves 40A and 41X are closed.

Now the rotary piston defines two operation chambers 23a and 23b at the bottom of FIG. 6. As soon as the corner 51B has passed the connection port of conduit 24A, valves 41A and 40X are opened and the sequence is repeated, wherein corner 51 is located at the bottom.

### Heat Engine According to Fifth Embodiment

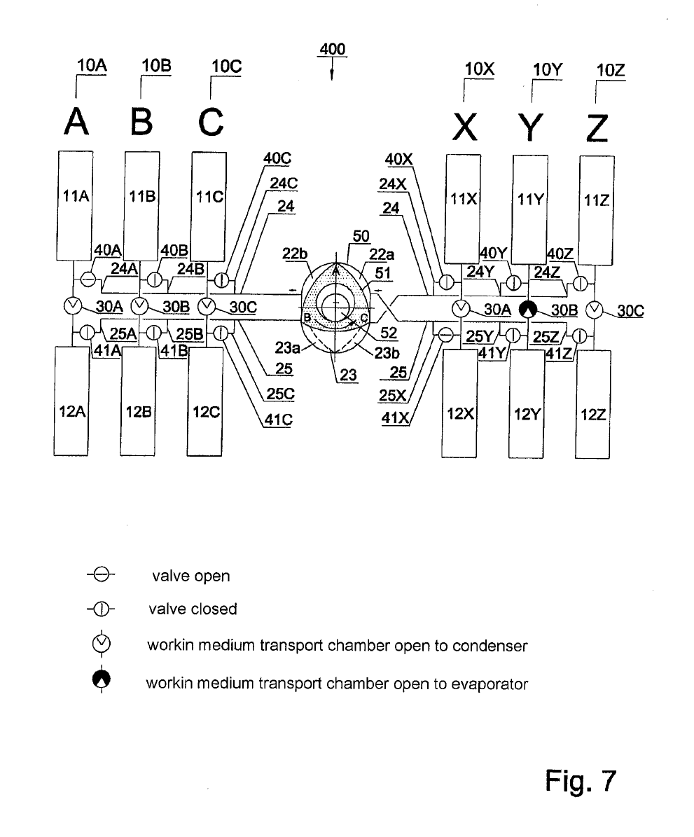

FIG. 7 shows a schematic representation of a fifth embodiment of a heat engine 400 according to the present invention. As in the fourth embodiment the drive system is a rotary piston engine 50. But contrary to the fourth embodiment the top operation chamber 22 is connected to multiple condensers 11A, 11B and 11C as well as multiple evaporators 12X, 12Y and 12Z and the bottom operation chamber 23 is connected to the condensers 11X, 11Y and 11Z as well as the evaporators 12A, 12B and 12C.

The rest of heat engine 400 according to the fifth embodiment is constructed of similar parts as heat engine 300. Therefore, corresponding parts are denoted by the same reference numbers. For parts on the left side (FIG. 6) of the rotary piston engine 50, “A”, “B” or “C” are added to the reference numbers (corresponding to pair of heat exchangers), and for parts on the right side (FIG. 6) of the rotary piston engine, “X”, “Y” and “Z” are added to the reference numbers. Furthermore, corresponding parts are not described in detail.

Heat engine 400 according to the fourth embodiment of the invention comprises six pairs of heat exchangers 10A, 10B, 10C, 10X, 10Y, 10Z, a rotary piston engine 50, six working medium transfer devices 30A, 30B, 30C, 30X, 30Y, 30Z and twelve valves 40A, 40B, 40C, 40X, 40Y, 40Z, 41A, 41B, 41C, 41X, 41Y, 41Z. Pairs of heat exchangers 10A-10Z each consist of a first heat exchanger or condenser 11A-11Z (hereinafter condenser) and a second heat exchanger or evaporator 12A-12Z (hereinafter evaporator). As in the first embodiment, each condenser 11A-11Z has a lower end part 13 and each evaporator 12A-12Z has an upper end part 14.

The upper end part 14 of each heat exchanger as well as the parts of the heat engine 400 described below may be insulated from the rest of evaporators 12A-12Z by insulation 15. The insulation is made from a material that is suitable for the pressures and the mechanical stress but is a bad heat conductor. Insulation 15 is employed to minimize the heat conduction from evaporators 12A-12Z to the rest of heat engine 400.

Both condensers 11A-11Z and evaporators 12A-12Z are shown as tube 16 having fins 17. It should be noted that other types of heat exchangers may also be employed. Further, it should be noted that, even though only one tube 16 is shown in the figures, each heat exchanger may comprise any number of tubes 16. Pairs of heat exchangers 10A-10Z may also have an appropriate design for a heat exchange by means of radiation.

In evaporators 12A-12Z, means for distributing the working medium over a large surface are arranged to allow for an improved heat transfer to the working medium.

Condensers 11A-11Z are surrounded by a flowing cooling medium 18. The cooling medium 18 may be gaseous or liquid. Evaporators 12A-12Z are surrounded by a flowing heating medium 19. The heating medium 19 may be gaseous or liquid as well. Each the lower end part 13 of condenser 11A-11Z and the upper end part 14 of evaporator 12A-12Z are connected to a working medium transfer device 30A-30Z. The respective working medium transfer device 30A-30Z comprises at least one working medium transport chamber 31 that may selectively be connected to the respective evaporator 12A-12Z and the respective condenser 11A-11Z.

As in the previously described embodiments, the working medium transfer devices 30A-30Z may be positioned in at least three positions. In the first position, the working medium transport chamber 31 is connected to the lower end part 13 of the condenser. In the second position, the working medium transport chamber 31 is disconnected from condensers 11A-11Z as well as from the evaporator. In the third position, the working medium transport chamber 31 is connected to the upper end part 14 of evaporator 12A-12Z. The working medium transfer device 30A-30Z may comprise an electric, pneumatic, hydraulic or other drive that may be actuated dependent on time according to the operation process described below in more detail.

### Operation of the Heat Engine According to the Fifth Embodiment

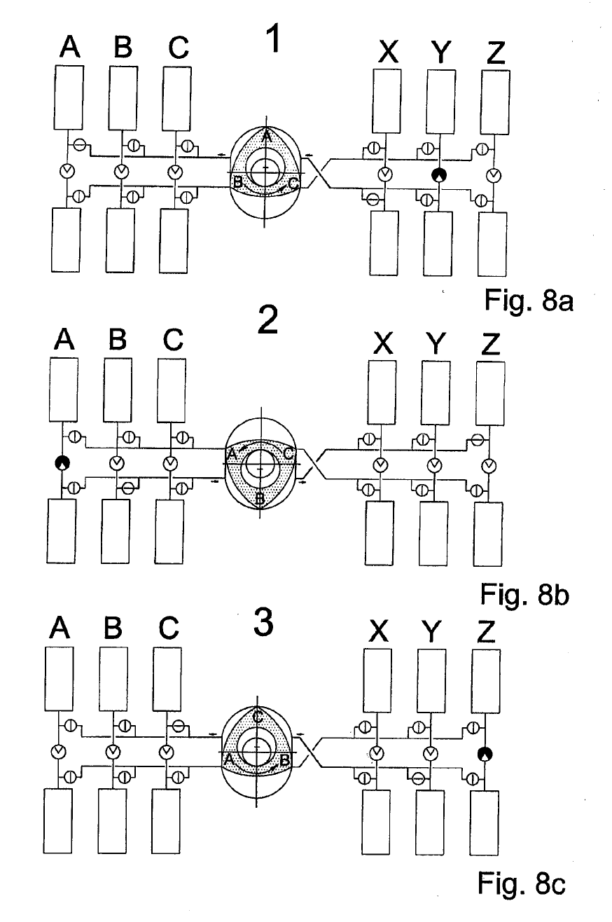

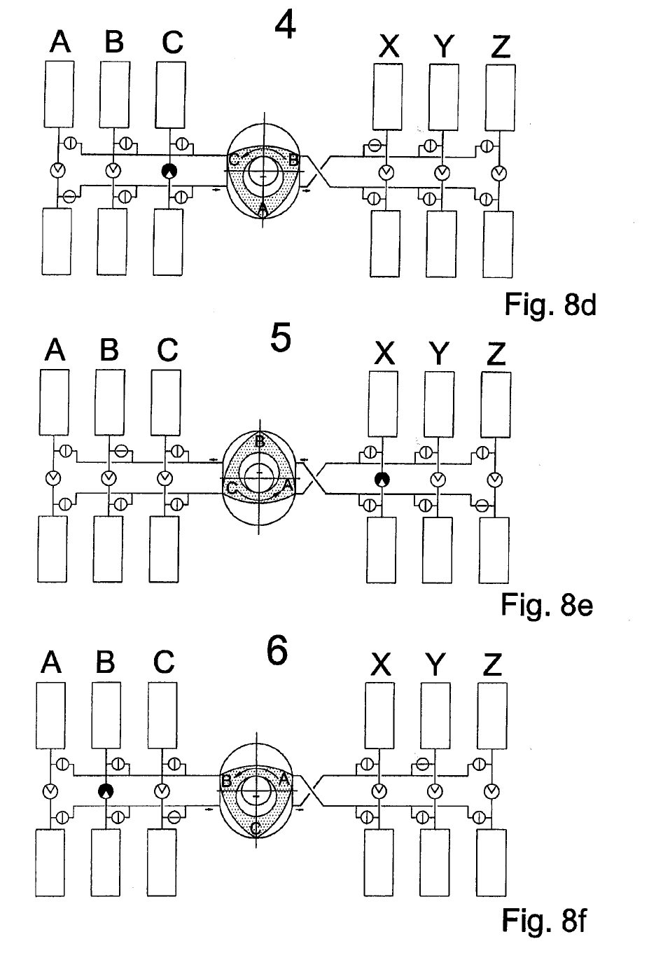

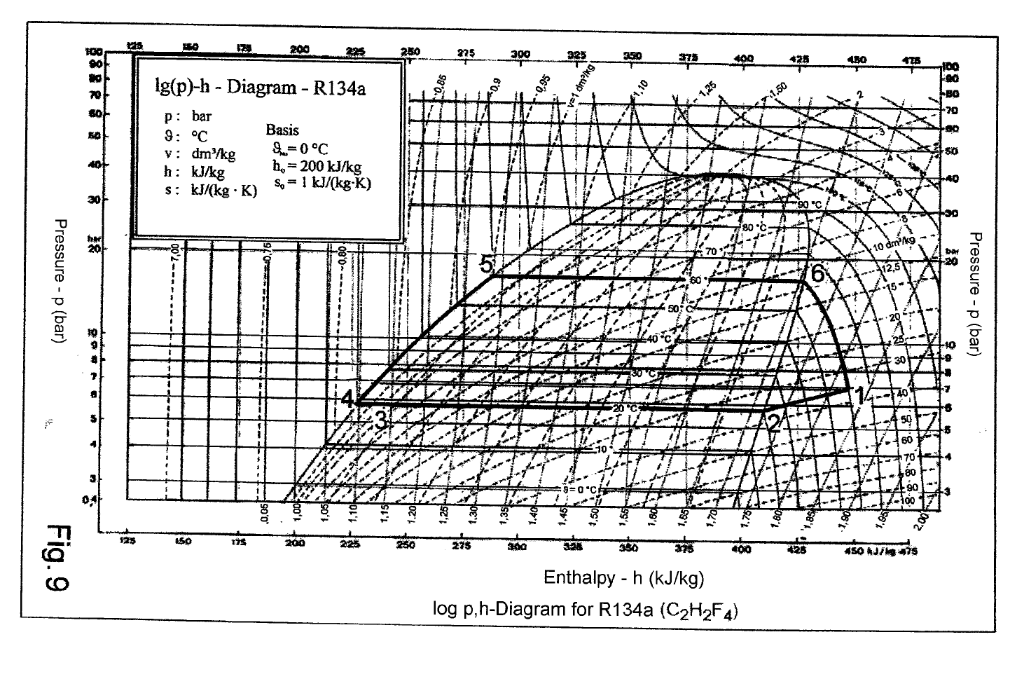

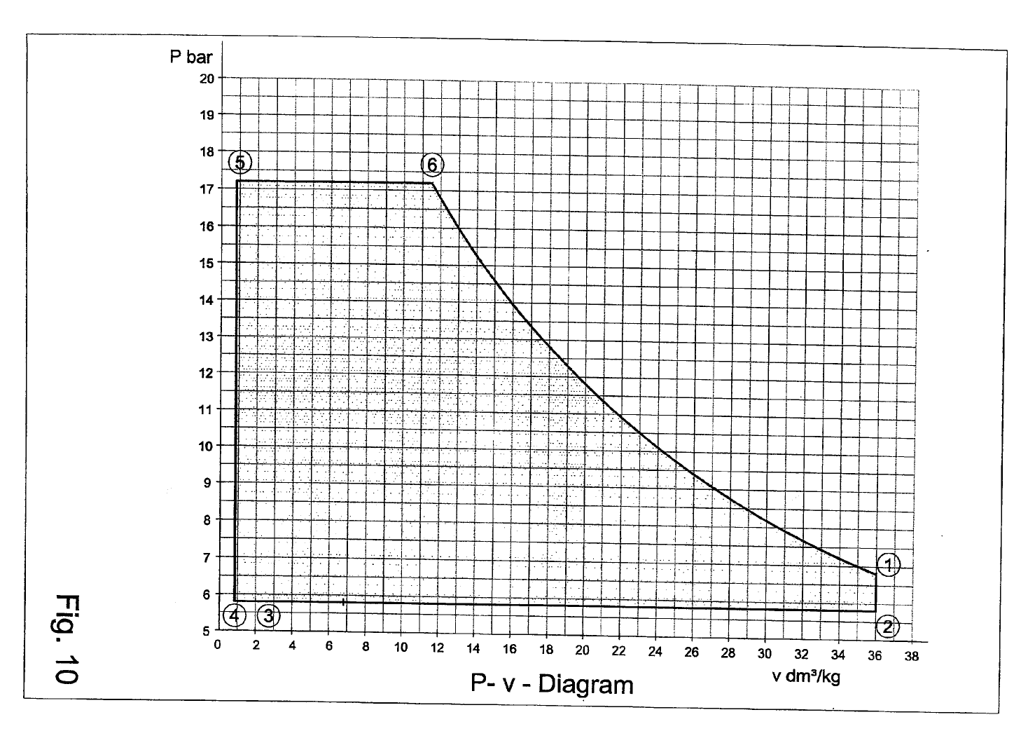

The operation of the heat engine according to the fifth embodiment is schematically shown in FIG. 8a-8f.

Stroke 1 (FIG. 8a)

Due to the cooling of condenser 11A, the enclosed working gas is cooled to the lower temperature level, and the pressure within condenser 11A corresponds maximally to the vapour pressure of the working medium at the temperature of the cooling medium. The working medium enclosed in evaporator 12X is also sufficiently heated up due to the continuous heating of evaporator 12X.

The rotary piston 51 is arranged as illustrated in FIG. 8a with corner 51A being directed upwards. Valve 40A at condenser 11A and valve 41X at evaporator 12X are opened. The pressures in condenser 11A and in evaporator 12X proceed in the respective conduits 24 and 24A as well as 25 and 25X to the operation chambers 22a and 22b. Due to the pressure difference between operation chamber 22a and operation chamber 22b on both sides of the eccentric part of rotary piston 51, the rotary piston is rotated counter-clockwise.

While the rotary piston is rotating, the condensate is transferred from condenser 11Y to evaporator 12Y via the working medium transfer device 30Y. As soon as corner 51A of rotary piston 51 reaches the connection of conduit 24 on the left side, valves 40A and 41X are closed and stroke 1 is finished.

Stroke 2 (FIG. 8b)

In the meantime the working medium in evaporator 12B is sufficiently heated, and the working medium in condenser 11Z is sufficiently cooled. Valves 41B at evaporator 12B and 40Z at condenser 11Z are opened at the same time, as soon as corner 51A has crossed the connection port of conduit 24 on the left side and corner 51C has passed the connection port of conduit 25 on the right side. The pressures within the condenser and within the evaporator continue in the respective conduits 25B and 24Z to the working cylinder 20. Due to the pressure difference, which now prevails between operation chambers 23a and 23b on both sides of the rotary piston 51, the rotary piston is further rotated counter-clockwise.

As the rotary piston rotates further, the condensate is transferred from condenser 11A to evaporator 12A by the working medium transfer device 30A. As soon as corner 51B of rotary piston 51 reaches the connection of conduit 24 on the right side, valves 41B and 40Z are closed and stroke 2 is finished.

Stroke 3 (FIG. 8c)

In the same way as described for stroke 1, the rotary piston 51 is rotated further counter-clockwise in stroke 3 by means of the action of the pressures from the evaporator 12Y and the condenser 11C and the resulting pressure difference therefrom, while the liquid condensed working medium is transferred from condenser 11Z into evaporator 12Z.

Stroke 4 (FIG. 8d)

As described in stroke 2 the rotary piston 51 is rotated further counter-clockwise in stroke 4 by means of the action of the pressure from evaporator 12A and condenser 11X and the resulting pressure difference that now occurs between the operation chambers 23a and 23b on both sides of rotary piston 51, while the liquid condensed working medium is transferred from condenser 11C into evaporator 12C.

Stroke 5 (FIG. 8e)

In the same way as described for stroke 1, the rotary piston 51 is rotated further counter-clockwise in stroke 5 by means of the action of the pressure from evaporator 12Z and condenser 11B and the resulting pressure difference that now occurs between 22a and 22b on both sides of the rotary piston 51, while the liquid condensed working medium is transferred from condenser 11X into evaporator 12X.

Stroke 6 (FIG. 8f)

As described for stroke 2, the rotary piston 51 is rotated further counter-clockwise in stroke 6 by means of the action of the pressure from evaporator 12C and condenser 11Y and the resulting pressure difference that now occurs between 23a and 23b on both sides of the rotary piston 51, while the liquid condensed working medium is transferred from condenser 11B into evaporator 12B.

After stroke 6 the process restarts again with stroke 1.

Again, it should be noted that, although six pairs of heat exchangers 10 were described in some embodiments, an arbitrary number of heat exchangers may be employed. Nevertheless, the number of pairs of heat exchangers on the left side has to correspond to the number on the right side.

It generally applies to all embodiments of the heat engine that a fast evaporation of the condensate introduced into an evaporator is advantageous to increase the output and to reduce the stroke or cycle times. The distribution means comprise metallic wool, metal threads, surface structures or heat transfer fins that are arranged inside the evaporator. Furthermore, it is considered to inject the condensate into the evaporator.

In all shown embodiments, heat engine 1, 100, 200, 300, 400 may drive a machine. In cooperation with a linear generator, the movement and work of the piston may be converted directly into electricity. The piston movement is alternatively transmitted by a drive rod on a crank shaft having fly wheel (both not shown) so that the performed work is delivered by the rotating crank shaft. In a design of heat engine 300, 400 having a rotary piston engine, the work may be converted into electricity by a conventional (rotating) generator.

As the utilization of heat by a single heat engine is limited by the obtainable temperature decrease with heat exchangers 10, it is contemplated that an arbitrary number of heat engines are connected in series. The heating medium flows through each heat engine in a cascade manner. In a similar way the cooling medium flows through the heat engine as well, but flows in an opposite direction and in a reversed order to the heating medium.

The temperature of the heating medium decreases with every passed heat engine. The temperature of the cooling medium increases with every passed heat engine. Due to the counter flow principle the temperature difference between the heating and the cooling medium remains more or less constant.

In each heat engine connected in series, different working media are employed that are adjusted to the respective temperature level.

Alternatively, several heat engines through which a hot medium flows in series may each be passed by a cooling medium with the same temperature.

In the present invention, the pairs of heat exchangers 10 are stationary and do not rotate around the working engine as described in publication DE 10 2005 013287. Condensers 11 are arranged at the top and evaporators 12 at the bottom. Condenser 11 and evaporator 12 may be steadily circumflowed by the heating or cooling medium.

Contrary to the heat engine described in publication DE 10 2005 013287, the internal space of the condenser and the evaporator of a pair of heat exchangers 10 are never connected to each other. For this reason a separate valve 40 and 41 respectively is necessary for each condenser 11 and evaporator 12. The internal space of the condenser 11 and the evaporator 12 are separated by the working medium transfer device 30, wherein the working medium transfer device 30 transports the condensed working medium from the condenser 11 into the evaporator 12, without a pressure equalization taking place between condenser 11 and evaporator 12.

In this invention, a rotary piston engine or another rotary machine may be employed in lieu of a cylinder with a piston, in which each change of state of the working medium acts directly upon the rotary piston.

The invention was described with respect to preferred embodiments. Those skilled in the art will gather that numerous modifications and designs are possible without departing from the spirit of the invention.

1. A heat engine comprising:
at least one pair of heat exchangers (10) that comprises a condenser (11) and an evaporator (12);
at least one working medium transfer device (30) arranged between the condenser (11) and the evaporator (12) of the pair of heat exchangers (10);
at least one working engine (20, 21; 50, 51) driven by the working medium;
a conduit (24) between condenser (11) and the working engine (20, 21; 50, 51);
a conduit (25) between evaporator (12) and the working engine (20, 21; 50, 51);
valve means (40, 41) arranged between the pair of heat exchangers (10) and the working engine and an intermediate fluid connection that can selectively be opened or closed.

2. The heat engine according to claim 1, wherein the valve means (40, 41) comprises:
a valve (40) arranged in the conduit between the condenser and the working engine (20, 21; 50, 51); and
a valve (41) arranged in the conduit between the evaporator and the working engine (20, 21; 50, 51).

3. The heat engine according to claim 1, wherein the condenser (11) defines an enclosed internal space and wherein the working medium transfer device (30) is connected to the lower part of the internal space.

4. The heat engine according to claim 1, wherein the evaporator (12) defines an enclosed internal space and wherein the working medium transfer device (30) is connected to the upper part of the internal space.

5. The heat engine according to claim 1, wherein the working medium transfer device comprises at least one switchable working medium transport chamber (31), which is selectively connected to the evaporator (12) in a first position, which is selectively connected to the condenser (11) in a second position and which is disconnected from the evaporator (12) and the condenser (11) in a third position.

6. The heat engine according to claim 1, wherein the working engine comprises a working piston (21; 51) defining at least one variable operating chamber (22, 23; 22a, 22b, 23a, 23b) in the working engine (20, 21; 50; 51).

7. The heat engine according to claim 1, wherein the working engine comprises a working piston (21) which defines a first and a second variable operating chamber (22, 23) in conjunction with the working cylinder (20).

8. The heat engine according to claim 6, wherein the conduit (24) between the condenser (11) and the working engine (20, 21; 50, 51) and the conduit (25) between the evaporator (12) and the working engine (20, 21; 50, 51) are both connected to the operating chamber (22, 23; 22a, 22b, 23a, 23b).

9. The heat engine according to claim 6, wherein a plurality of pairs of heat exchangers (10A-10Z) is provided, the condensers (11A-11Z) and evaporators (12A-12Z) thereof being connected to the operating chamber.

10. The heat engine according to claim 7, wherein at least two pairs of heat exchangers (10A-10Z) are provided, the condensers (11A-11Z) and evaporators (12A-12Z) thereof being connected to a first and second operating chamber (22, 23; 22a, 22b, 23a, 23b), respectively.

11. The heat engine according to claim 10, wherein a plurality of pairs of heat exchangers (10A-10C) is provided, the condensers (11A-11C) and evaporators (12A-12C) thereof being connected to the first operating chamber, and wherein another plurality of pairs of heat exchangers (10X-10Z) is provided the condensers (11Y-11Z) and evaporators (12Y-12Z) thereof being connected to the second operating chamber.

12. The heat engine according to claim 9, wherein means for distributing the working medium are arranged within the evaporators (12A-12Z).

13. The heat engine claim 12, wherein the means for distributing the working medium are suitable to distribute the working medium over a large surface in order to achieve a faster heat transfer to the working medium.

14. The heat engine according to claim 12, wherein the distribution means comprise an injection device, metal wool, metal filament or threads, surface structures or heat transfer fins that are arranged inside the evaporator (12A-12Z).

15. The heat engine according to claim 1 further comprising:
a plurality of pairs of heat exchangers (10A, 10B, 10C, 10X, 10Y, 10Z), each comprising a condenser (11A, 11B, 11C, 11X, 11Y, 11Z) and an evaporator (12A, 12B, 12C, 12X, 12Y, 12Z);
a plurality of working medium transfer devices (30A, 30B, 30C, 30X, 30Y, 30Z) each being arranged between the condenser and the evaporator of each pair of heat exchangers;
at least one working engine (20, 21) having first and second operating chambers (22, 23), wherein a first group of pairs of heat exchangers (10A, 10B, 10C) is connected to the first operating chamber (22), and wherein a second group of pairs of heat exchangers (10X, 10Y, 10Z) is connected to the second operating chamber (23);
conduits (24A, 24B, 24C) between the condensers (11A, 11B, 11C) of the first group of pairs of heat exchangers and the first operating chamber (22) of the at least one working engine;
conduits (24X, 24Y, 24Z) between the condensers (11X, 11Y, 11Z) of the second group of pairs of heat exchangers and the second operating chamber (23) of the working engine;
a plurality of valves (40A, 40B, 40C, 40X, 40Y, 40Z), wherein one of these valves is arranged between each condenser (11A-11Z) and the connected operating chamber of the at least one working engine respectively;
junction conduits (25A, 25B, 25C) between the evaporators of the first group of pairs of heat exchangers and the first operating chamber of the at least one working engine;
junction conduits (25X, 25Y, 25Z) between the evaporators of the second group of pairs of heat exchangers and the second operating chamber of the at least one working engine;
a plurality of valves (41A, 41B, 41C, 41X, 41Y, 41Z), wherein one of these valves is arranged between each evaporator (12A-12Z) and the connected operating chamber of the at least one working engine, respectively.

16. The heat engine according to claim 1 further comprising:
a plurality of pairs of heat exchangers (10A, 10B, 10C, 10X, 10Y, 10Z), each comprising a condenser (11A, 11B, 11C, 11X, 11Y, 11Z) and an evaporator (12A, 12B, 12C, 12X, 12Y, 12Z);
a plurality of working medium transfer devices (30A, 30B, 30C, 30X, 30Y, 30Z) each arranged between the condenser and the evaporator of each pair of heat exchangers;
at least one working engine (20, 21) having first and second operating chambers (22, 23), wherein a first group of pairs of heat exchangers (10A, 10B, 10C) is connected to the first operating chamber (22), and wherein a second group of pairs of heat exchangers (10X, 10Y, 10Z) is connected to the second operating chamber (23);
a conduit (24) between the condensers (11A, 11B, 11C) of the first group of pairs of heat exchangers and the first operating chamber of the at least one working engine, wherein each condenser (11A, 11B, 11C) is connected via a junction conduit (24A, 24B, 24C) to the conduit (24);
a conduit (24) between the condensers (11X, 11Y, 11Z) of the second group of pairs of heat exchangers and the second operating chamber of the working engine, wherein each condenser (11X, 11Y, 11Z) is connected via a junction conduit (24X, 24Y, 24Z) to the conduit (24), respectively;
a plurality of valves (40A, 40B, 40C, 40X, 40Y, 40Z), wherein one of these valves is arranged in the junction conduit (24A-24Z) between each condenser (11A-11Z) and the connected conduit (24), respectively;
a conduit (25) between the evaporators (12A, 12B, 12C) of the first group of pairs of heat exchangers and the first operating chamber of the working engine, wherein each evaporator (12A, 12B, 12C) is connected via a junction conduits (25A, 25B, 25C) to the conduit (25), respectively;
a conduit (25) between the evaporators (12X, 12Y, 12Z) of the second group of pairs of heat exchangers and the second operating chamber of the working engine, wherein each evaporator (12X, 12Y, 11Z) is connected via a junction conduit (25X, 25Y, 25Z) to the conduit (25), respectively;
a plurality of valves (41A, 41B, 41C, 41X, 41Y, 41Z), wherein one of these valves is arranged within the junction conduit (25A-25Z) between each evaporator (12A, 12B, 12C, 12X, 12Y, 12Z) and the respective conduit (25) connected thereto.

17. The heat engine according to claim 15 characterized in the first group and the second group consisting of three pairs of heat exchangers, respectively.

18. The heat engine according to claim 15, characterized in the working engine being a piston engine having linearly reciprocating piston.

19. The heat engine according to claim 15, characterized in the working engine being a rotary piston engine having a rotating piston.

20. The heat engine according to claim 15, characterized in the working medium transfer device (30) comprising two valves, a chamber for the intake of the working medium condensate being arranged between these.

21. A method for controlling a heat engine according to claim 1 comprising the following steps:
a) closing valve (40) between the working cylinder (20) and the condenser (11);
b) closing valve (41) between the working cylinder (20) and the evaporator (12);
c) condensing a gaseous working medium in the condenser (11);
d) collecting the condensed, liquid working medium in the working medium transport chamber (31) of the working medium transfer device (30);
e) opening valve (40) between the working cylinder (20) and the condenser (11);
f) introducing the gaseous working medium into the condenser (11);
g) collecting the condensed, liquid working medium in the working medium transport chamber (31) of the working medium transfer device (30);
h) closing valve (40) between the working cylinder (20) and the condenser (11);
i) pressure tight sealing of the condensed, liquid working medium in the working medium transport chamber (31) of the condenser (11);
j) directing the condensed, liquid working medium into the evaporator (12);
k) evaporating the liquid working medium within the evaporator (12);
l) opening valve (41) between the working cylinder (20) and the evaporator (12);
m) directing the evaporated working medium into the working cylinder (20);
n) closing valve (41) between the working cylinder (20) and the evaporator (12);
o) repeating the steps starting from step c).

22. The method according to claim 21, wherein the evaporation of the working medium of step k) takes place at least partly during the following steps: l) opening the valve (41) and m) directing into the working cylinder (20).

23. A method of controlling a heat engine according to claim 15 comprising the following steps:
a) opening the valves (40A, 41X), closing the valves (40B, 40C, 40X, 40Y, 40Z, 41A, 41B, 41C, 41Y, 41Z), collecting the condensed working medium in the working medium transfer devices (30A, 30B, 30C, 30X, 30Z);
b) opening the valves (41B, 40Z), closing the valves (40A, 40B, 40C, 40X, 40Y, 41A, 41C, 41Y, 41Y, 41Z), collecting the condensed working medium in the working medium transfer devices (30B, 30C, 30X, 30Y, 30Z);
c) opening the valves (40C, 41Y), closing the valves (40A, 40B, 40X, 40Y, 40Z, 41A, 41B, 41C, 41X, 41Z), collecting the condensed working medium in the working medium transfer devices (30A, 30B, 30C, 30X, 30Y);
d) opening the valves (40X, 41A), closing the valves (40A, 40B, 40C, 40Y, 40Z, 41B, 41C, 41X, 41Y, 41Z), collecting the condensed working medium in the working medium transfer devices (30A, 30B, 30X, 30Y, 30Z);
e) opening the valves (40B, 41Z), closing the valves (40A, 40C, 40X, 40Y, 40Z, 41A, 41B, 41C, 41X, 41Y), collecting the condensed working medium in the working medium transfer devices (30A, 30B, 30C, 30Y, 30Z);
f) opening the valves (40Y, 41C), closing the valves (40A, 40B, 40C, 40X, 40Z, 41A, 41B, 41X, 41Y, 41Z), collecting the condensed working medium in the working medium transfer devices (30A, 30C, 30X, 30Y, 30Z);
g) repeating steps a) to f).

24. The heat engine according to claim 16, characterized in the working engine being a piston engine having linearly reciprocating piston.

25. The heat engine according to claim 16, characterized in the working engine being a rotary piston engine having a rotating piston.

26. The heat engine according to claim 16, characterized in the working medium transfer device (30) comprising two valves, a chamber for the intake of the working medium condensate being arranged between these.

27. A method of controlling a heat engine according to claim 16 comprising the following steps:
a) opening the valves (40A, 41X), closing the valves (40B, 40C, 40X, 40Y, 40Z, 41A, 41B, 41C, 41Y, 41Z), collecting the condensed working medium in the working medium transfer devices (30A, 30B, 30C, 30X, 30Z);
b) opening the valves (41B, 40Z), closing the valves (40A, 40B, 40C, 40X, 40Y, 41A, 41C, 41Y, 41Y, 41Z), collecting the condensed working medium in the working medium transfer devices (30B, 30C, 30X, 30Y, 30Z);
c) opening the valves (40C, 41Y), closing the valves (40A, 40B, 40X, 40Y, 40Z, 41A, 41B, 41C, 41X, 41Z), collecting the condensed working medium in the working medium transfer devices (30A, 30B, 30C, 30X, 30Y);
d) opening the valves (40X, 41A), closing the valves (40A, 40B, 40C, 40Y, 40Z, 41B, 41C, 41X, 41Y, 41Z), collecting the condensed working medium in the working medium transfer devices (30A, 30B, 30X, 30Y, 30Z);
e) opening the valves (40B, 41Z), closing the valves (40A, 40C, 40X, 40Y, 40Z, 41A, 41B, 41C, 41X, 41Y), collecting the condensed working medium in the working medium transfer devices (30A, 30B, 30C, 30Y, 30Z);
f) opening the valves (40Y, 41C), closing the valves (40A, 40B, 40C, 40X, 40Z, 41A, 41B, 41X, 41Y, 41Z), collecting the condensed working medium in the working medium transfer devices (30A, 30C, 30X, 30Y, 30Z);
g) repeating steps a) to f).
